(19) United States
(12) Patent Application Publication
(10) Pub. No.: US 2024/0276202 A1
(43) Pub. Date: Aug. 15, 2024

(54) DUAL SUBSCRIBER IDENTITY MODULE (SIM) TRANSMISSION METHOD AND APPARATUS THEREOF

(71) Applicant: MEDIATEK INC., Hsinchu City (TW)

(72) Inventors: Ming LEE, Hsinchu City (TW); Tsung-Ming LEE, Hsinchu City (TW)

(21) Appl. No.: 18/520,985

(22) Filed: Nov. 28, 2023

Related U.S. Application Data
(60) Provisional application No. 63/444,245, filed on Feb. 9, 2023.

(51) Int. Cl. H04W 8/18; H04W 76/15

(52) U.S. Cl. CPC H04W 8/183; H04W 76/15; H04W 88/06

(57) ABSTRACT

A dual Subscriber Identity Module (SIM) transmission method is provided. The dual SIM transmission method may include the following steps. A first SIM of an apparatus may perform a first service from a first serving cell. Then, a processor of the apparatus may determine whether the apparatus needs to be switched to a dual SIM dual active (DSDA) mode in response to a second SIM of the apparatus requiring a second service while the first SIM is performing the first service. In response to determining that the apparatus needs to be switched to the DSDA mode, the processor may select a target cell to make the apparatus support the DSDA mode.

### CROSS REFERENCE TO RELATED APPLICATIONS

This application claims the benefits of U.S. Provisional Application No. 63/444,245 filed on Feb. 9, 2023, the entirety of which is incorporated by reference herein.

### BACKGROUND OF THE INVENTION

### Field of the Invention

The invention generally relates to wireless communication technology, and more particularly, to a dual Subscriber Identity Module (SIM) transmission technology in which the UE can select a target cell to make sure that the UE can support the dual SIM dual active (DSDA) mode.

### Description of the Related Art

GSM/GPRS/EDGE technology is also called 2G cellular technology, WCDMA/CDMA-2000/TD-SCDMA technology is also called 3G cellular technology, and LTE/LTE-A/TD-LTE technology is also called 4G cellular technology. These cellular technologies have been adopted for use in various telecommunication standards to provide a common protocol that enables different wireless devices to communicate on a municipal, national, regional, and even global level. An example of an emerging telecommunication standard is 5G New Radio (NR), which is a set of enhancements to the LTE mobile standard promulgated by the Third Generation Partnership Project (3GPP). It is designed to better support mobile broadband Internet access by improving spectral efficiency, reducing costs, and improving services.

In conventional technology, user equipment (UE) may support a DA (Dual Active) transmission, e.g., dual SIM dual active (DSDA) or dual-receive DSDA (DR-DSDA). Users of dual SIM devices may want to enjoy services provided by operators on both SIMs simultaneously. For example, when one SIM of a device is using internet-based services, the other SIM may have an incoming call to respond to. Users wish that both SIM services can continue. Furthermore, the requirements for multiple SIMs having simultaneous access to the internet are more popular than ever. Enterprises can cooperate with telecom operators to promote specific SIMs that focus on services such as gaming, live streaming, etc. Therefore, the performance of the dual SIM device will be a key factor when consumers make purchasing decisions.

More practical dual active cases (i.e., services provided on both SIMs are performed simultaneously) can be achieved by DR-DSDA (i.e., transmission time-division-multiplexing (TX TDM) between both SIMs) with lower hardware costs. However it may suffer poor performance as time resources are shared. In other words, the dual SIM device in the DR-DSDA mode may waste uplink (UL) resources (e.g., physical random access channel (PRACH), physical uplink shared channel (PUSCH), physical uplink control channel (PUCCH) and sounding reference signal (SRS)) configured by base station, as a result, a dual SIM device in the DR-DSDA mode may be penalized by the base station in the current implementation.

Therefore, how to efficiently and flexibly make sure that the dual SIM device can support the DSDA mode in the dual active cases is a topic that is worthy of discussion.

### BRIEF SUMMARY OF THE INVENTION

A dual Subscriber Identity Module (SIM) transmission method and an apparatus are provided to overcome the problems mentioned above.

An embodiment of the invention provides a dual Subscriber Identity Module (SIM) transmission method. The dual SIM transmission method may include the following steps. A first SIM of an apparatus may perform a first service from a first serving cell. Then, a processor of the apparatus may determine whether the apparatus needs to be switched to a dual SIM dual active (DSDA) mode in response to a second SIM of the apparatus requiring a second service while the first SIM is performing the first service. In response to determining that the apparatus needs to be switched to the DSDA mode, the processor may select a target cell to make the apparatus support the DSDA mode.

In some embodiments, the second SIM is in a non-connected mode or in a connected mode.

In some embodiments, in response to the second SIM being in the non-connected mode, the method further comprises the following steps. The processor may select the target cell through a cell re-selection process or a cell selection process to make the apparatus support the DSDA mode. Then, the second SIM may camp on the target cell to perform the second service.

In some embodiments, in response to the second SIM being in the non-connected mode, the method further comprises the following steps. The processor may select the target cell through a cell re-selection process or a cell selection process to make the apparatus support the DSDA mode. Then, the second SIM may camp on a second serving cell to perform the second service. In addition, the first SIM may camp on the target cell from the first serving cell to perform the first service.

In some embodiments, in response to the second SIM being in the non-connected mode, a Tracking Area Update (TAU) procedure or a Mobility Registration Update (MRU) procedure may be performed before camping on the target cell.

In some embodiments, in response to the second SIM being in the connected mode, the method further comprises the following steps. The second SIM may modify a measurement report to switch to the target cell to make the apparatus support the DSDA mode. Then, the second SIM may transmit the modified measurement report to a second serving cell. Then, the second SIM may switch from the second serving cell to the target cell based on a handover procedure to perform the second service.

In some embodiments, in response to the second SIM being in the connected mode, the method further comprises the following steps. The first SIM may modify a measurement report to switch to the target cell to make the apparatus support the DSDA mode. Then, the first SIM may transmit the modified measurement report to a second serving cell. Then, the second SIM may perform the second service from the second serving cell. In addition, the first SIM may switch from the first serving cell to the target cell based on a handover procedure to perform the first service.

In some embodiments, in response to the second SIM being in the connected mode, the method may further comprise that the first SIM or the second SIM may modify a measurement report by increasing the signal quality of the target cell.

In some embodiments, the connected mode may be a radio resource control (RRC) connected mode, and the non-connected mode may be an RRC idle mode or an RRC inactive mode.

In some embodiments, the method may further comprise that the processor may determine the apparatus needs to be switched to a DSDA mode in response to the apparatus currently being in a dual receive-DSDA (DR-DSDA) mode.

An embodiment of the invention provides apparatus for dual Subscriber Identity Module (SIM) transmission. The apparatus may comprise a first SIM, a second SIM, a transceiver and a processor. The processor may be coupled to the first SIM, the second SIM and the transceiver. The processor may be configured to perform a first service from a first serving cell via a first SIM. The processor may be configured to determine whether the apparatus needs to be switched to a dual SIM dual active (DSDA) mode in response to a second SIM of the apparatus requiring a second service while the first SIM is performing the first service. In addition, the processor may be configured to select a target cell to make the apparatus support the DSDA mode in response to determining that the apparatus needs to be switched to the DSDA mode.

Other aspects and features of the invention will become apparent to those with ordinary skill in the art upon review of the following descriptions of specific embodiments of dual SIM transmission method and an apparatus.

### BRIEF DESCRIPTION OF THE DRAWINGS

The invention will become more fully understood by referring to the following detailed description with reference to the accompanying drawings, wherein:

FIG. 1 is a block diagram of a wireless communications system 100 according to an embodiment of the invention.

FIG. 2 is a block diagram of a communication apparatus 200 according to an embodiment of the invention.

FIG. 3 is a block diagram of a network apparatus 300 according to an embodiment of the invention.

FIG. 4 is a schematic diagram illustrating switching to DSDA mode according to an embodiment of the invention.

FIG. 5 is a schematic diagram illustrating switching to DSDA mode according to another embodiment of the invention.

FIG. 6 is a schematic diagram illustrating switching to DSDA mode according to another embodiment of the invention.

FIG. 7 is a schematic diagram illustrating switching to DSDA mode according to another embodiment of the invention.

FIG. 8 is a flow chart illustrating a dual SIM transmission method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

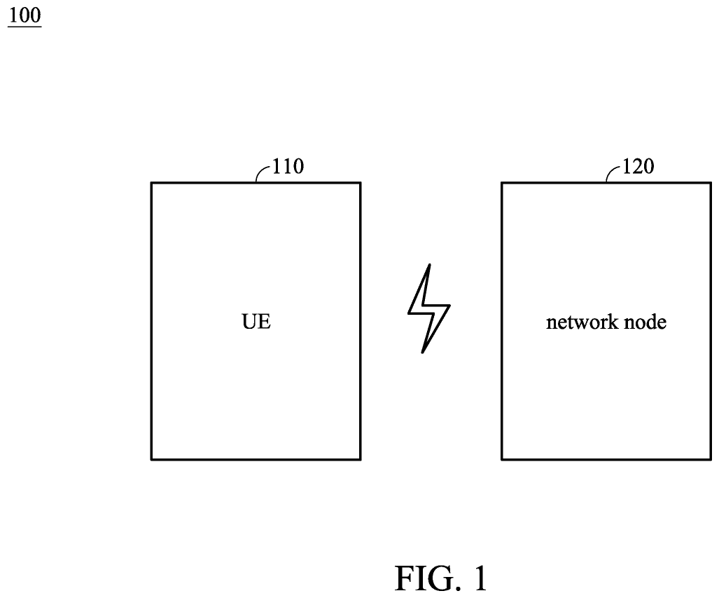

FIG. 1 is a block diagram of a wireless communications system 100 according to an embodiment of the invention. As shown in FIG. 1, the wireless communications system 100 may comprise user equipment (UE) 110 and a network node 120. It should be noted that in order to clarify the concept of the invention, FIG. 1 presents a simplified block diagram in which only the elements relevant to the invention are shown. However, the invention should not be limited to what is shown in FIG. 1.

In the embodiments of the invention, the UE 110 may be a smartphone, Personal Data Assistant (PDA), pager, laptop computer, desktop computer, wireless handset, or any computing device that includes a wireless communications interface.

In the embodiments, the network node 120 may be a base station, a gNodeB (gNB), a NodeB (NB) an eNodeB (eNB), an access point, an access terminal, but the invention should not be limited thereto. In the embodiments, the UE 110 may communicate with the network node 120 through the fourth generation (4G) communication technology, fifth generation (5G) communication technology (or 5G New Radio (NR) communication technology), or sixth generation (6G) communication technology, but the invention should not be limited thereto.

According to an embodiment of the invention, the UE 110 may wirelessly communicate with both the service network nodes (e.g., network node 120 and another network node) using two separate subscriber identities (or referred to as subscriber numbers). The subscriber identities may be provided by two subscriber identity cards (e.g., Subscriber Identity Module (SIM) cards or Universal SIM (USIM) cards) (not shown) in compliance with the specifications of the RAT utilized by different service network nodes. That is, the UE 110 may be a dual SIM device. The UE 110 may support a dual SIM dual active (mode) or dual-receive DSDA (DR-DSDA) mode based on the serving cells corresponding to its SIMs.

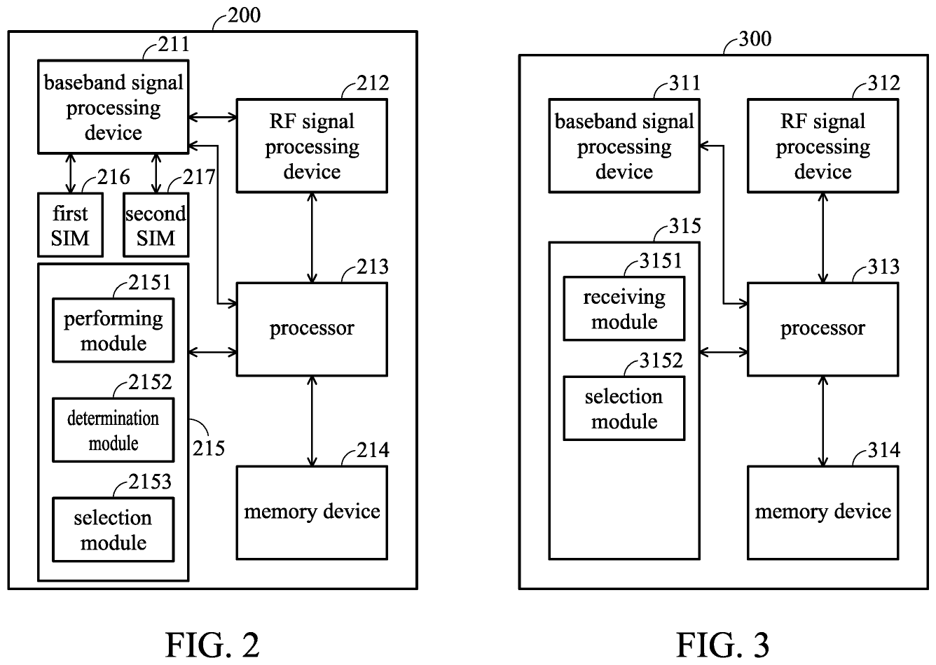

FIG. 2 is a block diagram of a communication apparatus 200 according to an embodiment of the invention. The communication apparatus 200 may be applied to UE 110. As shown in FIG. 2, the communication apparatus 200 may comprise at least a baseband signal processing device 211, a radio frequency (RF) signal processing device 212, a processor 213, a memory device 214, function modules and circuits 215, a first SIM 216, and a second SIM 217.

The RF signal processing device 212 may be a transceiver. The RF signal processing device 212 may comprise a plurality of antennas to receive or transmit RF signals. The RF signal processing device 212 may receive RF signals via the antennas and process the received RF signals to convert the received RF signals to baseband signals to be processed by the baseband signal processing device 211, or receive baseband signals from the baseband signal processing device 211 and convert the received baseband signals to RF signals to be transmitted to a peer communications apparatus. The RF signal processing device 212 may comprise a plurality of hardware elements to perform radio frequency conversion. For example, the RF signal processing device 212 may comprise a power amplifier, a mixer, analog-to-digital converter (ADC)/digital-to-analog converter (DAC), etc.

The baseband signal processing device 211 may further process the baseband signals to obtain information or data transmitted by the peer communications apparatus. The baseband signal processing device 211 may also comprise a plurality of hardware elements to perform baseband signal processing.

The processor 213 may control the operations of the baseband signal processing device 211, the RF signal processing device 212, the memory device 214 and the function modules and circuits 215. According to an embodiment of the invention, the processor 213 may also be arranged to execute the program codes of the software module(s) of the corresponding baseband signal processing device 211, the RF signal processing device 212 and the function modules and circuits 215. The program codes accompanied by specific data in a data structure may also be referred to as a processor logic unit or a stack instance when being executed. Therefore, the processor 213 may be regarded as being comprised of a plurality of processor logic units, each for executing one or more specific functions or tasks of the corresponding software modules.

The memory device 214 may store the software and firmware program codes, system data, user data, etc. of the communication apparatus 200. The memory device 214 may be a volatile memory such as a Random Access Memory (RAM); a non-volatile memory such as a flash memory or Read-Only Memory (ROM); a hard disk; or any combination thereof. The memory device 214 may stores a look-up table for adjusting the RS reception scheduling.

According to an embodiment of the invention, the RF signal processing device 212 and the baseband signal processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module, and the invention should not be limited to what is shown in FIG. 2.

The function modules and circuits 215 may comprise a performing module 2151, a determination module 2152 and a selection module 2153. The processor 213 may execute different modules or circuits in the function modules and circuits 215 to perform embodiments of the present invention. In the embodiment of the invention, the performing module 2151 may perform a first service from a first serving cell through the first SIM 216 and perform a second service from a second serving cell through the second SIM 217. The determination module 2152 may determine whether the communication apparatus 200 need to be switched to a dual SIM dual active (DSDA) mode in response to the second SIM 217 requiring the second service while the first SIM 216 is performing the first service. The selection module 2153 may select a target cell to make that the communication apparatus 200 can support the DSDA mode.

According to an embodiment of the invention, the communication apparatus 200 may perform wireless transmission and reception to and from the cells formed by the two different service network nodes using two subscriber identity cards. That is, two subscriber identity cards may be allocated in the communication apparatus 200 respectively for the different services from different network nodes.

FIG. 3 is a block diagram of a network apparatus 300 according to an embodiment of the invention. The network apparatus 300 may be applied to the network node 120. As shown in FIG. 3, the network apparatus 300 may comprise at least a baseband signal processing device 311, a RF signal processing device 312, a processor 313, a memory device 314, and function modules and circuits 315.

The RF signal processing device 312 may be a transceiver. The RF signal processing device 312 may comprise a plurality of antennas to receive or transmit RF signals. The RF signal processing device 312 may receive RF signals via the antennas and process the received RF signals to convert the received RF signals to baseband signals to be processed by the baseband signal processing device 311, or receive baseband signals from the baseband signal processing device 311 and convert the received baseband signals to RF signals to be transmitted to a peer communications apparatus. The RF signal processing device 312 may comprise a plurality of hardware elements to perform radio frequency conversion. For example, the RF signal processing device 312 may comprise a power amplifier, a mixer, ADC/DAC, etc.

The baseband signal processing device 311 may further process the baseband signals to obtain information or data transmitted by the peer communications apparatus. The baseband signal processing device 311 may also comprise a plurality of hardware elements to perform baseband signal processing.

The processor 313 may control the operations of the baseband signal processing device 311, the RF signal processing device 312, the memory device 314 and the function modules and circuits 315. According to an embodiment of the invention, the processor 313 may also be arranged to execute the program codes of the software module(s) of the corresponding baseband signal processing device 311, the RF signal processing device 312 and the function modules and circuits 315. The program codes accompanied by specific data in a data structure may also be referred to as a processor logic unit or a stack instance when being executed. Therefore, the processor 313 may be regarded as being comprised of a plurality of processor logic units, each for executing one or more specific functions or tasks of the corresponding software modules.

The memory device 314 may store the software and firmware program codes, system data, user data, etc. of the network node apparatus 300. The memory device 314 may be a volatile memory such as a RAM; a non-volatile memory such as a flash memory or ROM; a hard disk; or any combination thereof. The memory device 314 may stores a look-up table for adjusting the RS reception scheduling.

According to an embodiment of the invention, the RF signal processing device 312 and the baseband signal processing device 311 may collectively be regarded as a radio module capable of communicating with a wireless network to provide wireless communications services in compliance with a predetermined Radio Access Technology (RAT). Note that, in some embodiments of the invention, the network apparatus 300 may be extended further to comprise more than one antenna and/or more than one radio module, and the invention should not be limited to what is shown in FIG. 3.

The function modules and circuits 315 may comprise a receiving module 3151, and a selection module 3152. The processor 313 may execute different modules or circuits in the function modules and circuits 315 to perform embodiments of the present invention. In the embodiment of the invention, the receiving module 3151 may receive the modified measurement report from the UE. The selection module 3152 may select a target cell based on the modified measurement report to make that the UE can support the DSDA mode.

According to an embodiment of the invention, the UE 110 may perform a first service from a first serving cell through the first SIM and perform a second service from a second serving cell through the second SIM. In an embodiment of the invention, the first service may be internet browsing, file downloading, but the invention should not be limited thereto. In an embodiment of the invention, the second service may be a more critical service or a real-time service, e.g. an IP multimedia subsystem (IMS) call, a Voice over Internet Protocol (VoIP) call, gaming, but the invention should not be limited thereto.

When second SIM of the UE 110 requires the second service and the UE 110 is performing the first service from the first serving cell through the first SIM of the UE 110 (i.e., the SIM is in a connected mode), the UE 110 may determine whether the UE 110 need to be switched to a dual SIM dual active (DSDA) mode, i.e., the UE 110 may determine whether it currently supports the DSDA mode. When the UE 110 determines that it needs to be switched to the DSDA mode, (i.e., the UE 110 does not currently support the DSDA mode, e.g., the UE 110 may only support DR-DSDA mode), the UE 110 may select a target cell to make sure that the UE 110 can support the DSDA mode. In the scenario, the second SIM may be in a connected mode or in a non-connected mode.

According to an embodiment of the invention, the connected mode may be a radio resource control (RRC) connected mode, and the non-connected mode may be an RRC idle mode or an RRC inactive mode.

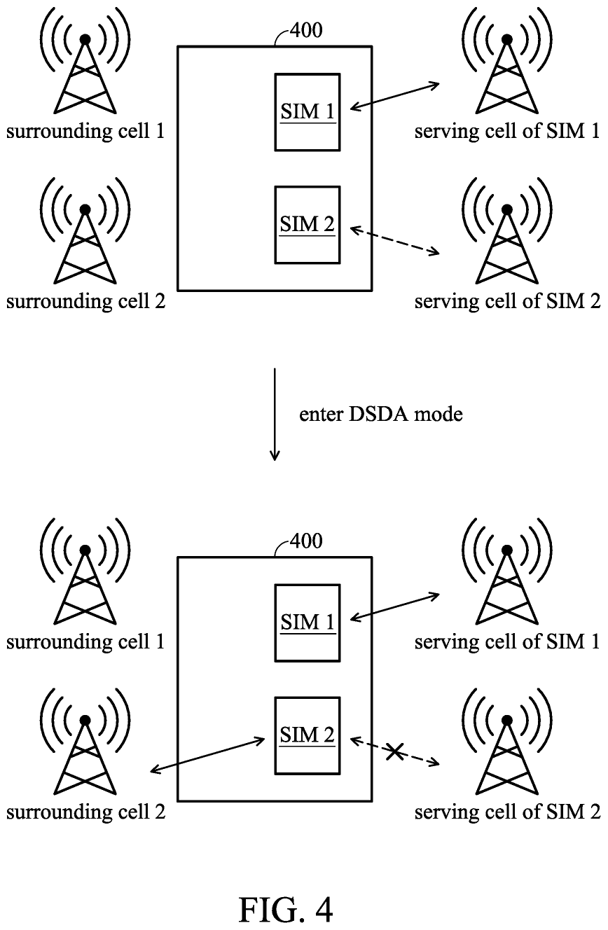

According to a first embodiment of the invention, when the second SIM is in a non-connected mode, the UE 110 may select the target cell through a cell re-selection process or a cell selection process to make sure that the UE 110 can support the DSDA mode. For example, the UE 110 may perform the cell selection process to select the target based on the historical cells recoded in the memory device of the UE 110 or neighbor (or surrounding) cell information carried in the system information block x (SIBx) to make sure that the UE 110 can support or enter the DSDA mode. After the UE 110 selects the target cell, the second SIM may camp on the target cell to perform the second service while the UE 110 is performing the first service from the first serving cell. FIG. 4 is taken as an example to illustrate the first embodiment below.

In addition, in the first embodiment, when the target cell and the serving cell originally corresponding to the second SIM do not correspond to the same tracking area or the same mobility, the UE 110 may perform a Tracking Area Update (TAU) procedure or a Mobility Registration Update (MRU) procedure before the second SIM camps on the target cell.

FIG. 4 is a schematic diagram illustrating switching to DSDA mode according to the first embodiment of the invention. The UE 400 can be applied to UE 110. As shown in FIG. 4, it is assumed that the SIM 1 is in the connected mode, the SIM 2 is in the non-connected mode, and the UE 400 can currently only support DR-DSDA mode. When SIM 2 requires the second service and the UE 400 is performing the first service from the serving cell corresponding to the SIM 1, the UE 400 may select a target cell to make sure that the UE 400 can support the DSDA mode. After the UE 400 selects the target cell (i.e., surrounding cell 2), the SIM 2 may camp on the target cell to perform the second service while the UE 110 is performing the first service from the first serving cell corresponding to SIM 1. That is, the SIM 2 may camp on the target cell without camping on the original serving cell corresponding to the SIM 2 to make sure that the UE 400 can support or enter the DSDA mode.

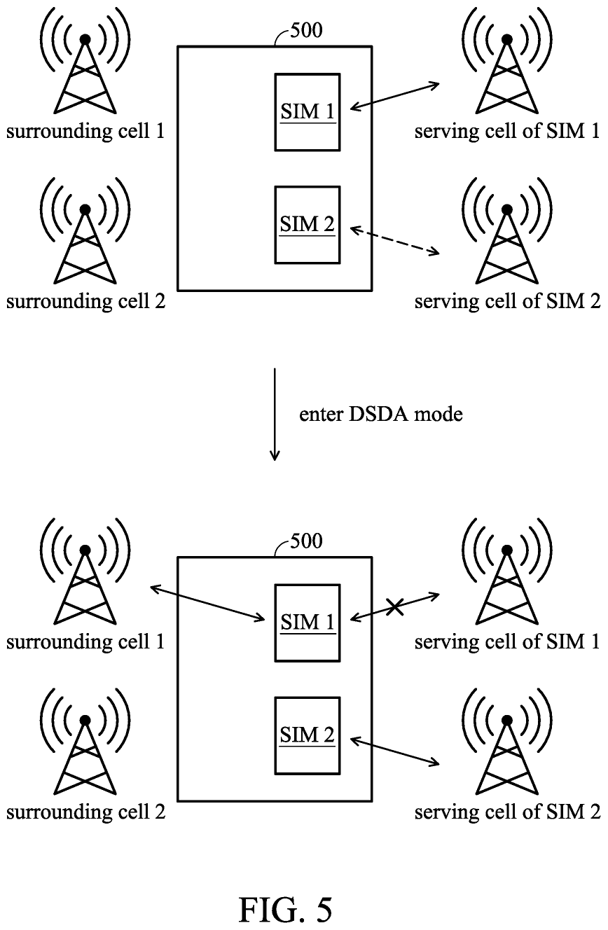

According to a second embodiment of the invention, when the second SIM is in a non-connected mode, after the UE 110 selects the target cell, the first SIM may be switched to camp on the target cell to perform the first service and the second SIM may camp on the serving cell corresponding to the second SIM to perform the second service. Specifically, the UE 110 may release the original connection (e.g., RRC connection) with the serving cell corresponding to the first SIM first. Then, the first SIM may camp on the target cell to perform the first service, and the second SIM may camp on the serving cell corresponding to the second SIM to perform the second service to make sure that the UE 110 can support or enter the DSDA mode. FIG. 5 is taken as an example to illustrate the second embodiment below.

In addition, in the second embodiment, when the target cell and the serving cell originally corresponding to the first SIM do not correspond to the same tracking area or the same mobility, the UE 110 may perform a Tracking Area Update (TAU) procedure or a Mobility Registration Update (MRU) procedure before the first SIM camps on the target cell.

FIG. 5 is a schematic diagram illustrating switching to DSDA mode according to the second embodiment of the invention. The UE 500 can be applied to UE 110. As shown in FIG. 5, it is assumed that the SIM 1 is in the connected mode, the SIM 2 is in the non-connected mode, and the UE 500 can currently only support DR-DSDA mode. When SIM 2 requires the second service and the UE 500 is performing the first service from the serving cell corresponding to the SIM 1, the UE 500 may select a target cell to make sure that the UE 500 can support the DSDA mode. After the UE 500 selects the target cell (i.e., surrounding cell 1), the UE 500 may release the original connection (e.g., RRC connection) with the serving cell corresponding to the SIM 1. Then, the SIM 1 may camp on the target cell (i.e., surrounding cell 1) to perform the first service, and the SIM 2 may camp on the serving cell corresponding to the SIM 2 to perform the second service to make sure that the UE 500 can support or enter the DSDA mode.

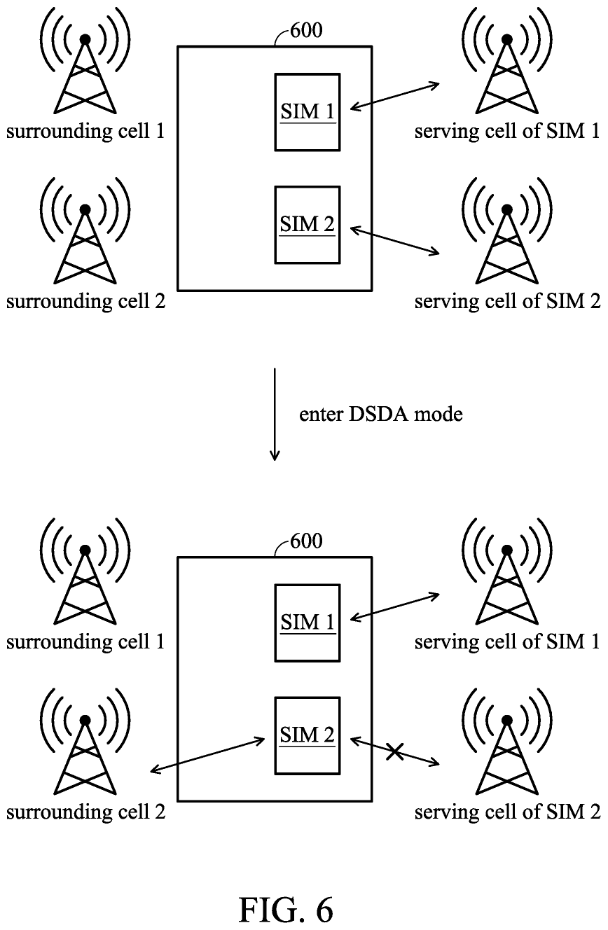

According to a third embodiment of the invention, when the second SIM is in a connected mode, the UE 110 may modify a measurement report to switch to the target cell to make sure that the UE 110 can support the DSDA mode. Specifically, the UE 110 may find at least one surrounding cell which can make the UE 110 can support the DSDA mode, and then the UE 110 may increase the signal quality of the found surrounding cells and reduce the signal quality of the cells which cannot make the UE 110 can support the DSDA mode to modify the measurement report. Then, the UE 110 may transmit the modified measurement report to the network node corresponding to the serving cell of the second SIM through the second SIM. When the network node corresponding to the serving cell of second SIM receives the modified measurement report, the network node may select a target cell from the found surrounding cells and perform a handover procedure (e.g., transmit a handover command to the second SIM) to switch the second SIM from the original serving cell to the target cell. After the handover procedure, the second SIM may camp on the target cell to perform the second service while the UE 110 is performing the first service from the first serving cell to make sure that the UE 110 can support or enter the DSDA mode. FIG. 6 is taken as an example to illustrate the third embodiment below.

FIG. 6 is a schematic diagram illustrating switching to DSDA mode according to the third embodiment of the invention. The UE 600 can be applied to UE 110. As shown in FIG. 6, it is assumed that the SIM 1 is in the connected mode, the SIM 2 is in the connected mode, and the UE 600 can currently only support DR-DSDA mode. When SIM 2 requires the second service and the UE 600 is performing the first service from the serving cell corresponding to the SIM 1, the UE 600 may find at least one surrounding cell which can make the UE 110 can support the DSDA mode, and then the UE 600 may increase the signal quality of the found surrounding cells and reduce the signal quality of the cells which cannot make the UE 600 can support the DSDA mode to modify the measurement report. Then, the UE 600 may transmit the modified measurement report to the network node corresponding to the serving cell of SIM 2. When the network node corresponding to the serving cell of SIM 2 receives the modified measurement report, the network node may select the target cell (i.e., surrounding cell 2) from the found surrounding cells and perform a handover procedure (e.g., transmit a handover command to the SIM 2) to switch the SIM 2 from the original serving cell to the target cell (i.e., surrounding cell 2). After the handover procedure, the SIM 2 may camp on the target cell to perform the second service while the UE 600 is performing the first service from the serving cell corresponding to the SIM 1 to make sure that the UE 600 can support or enter the DSDA mode.

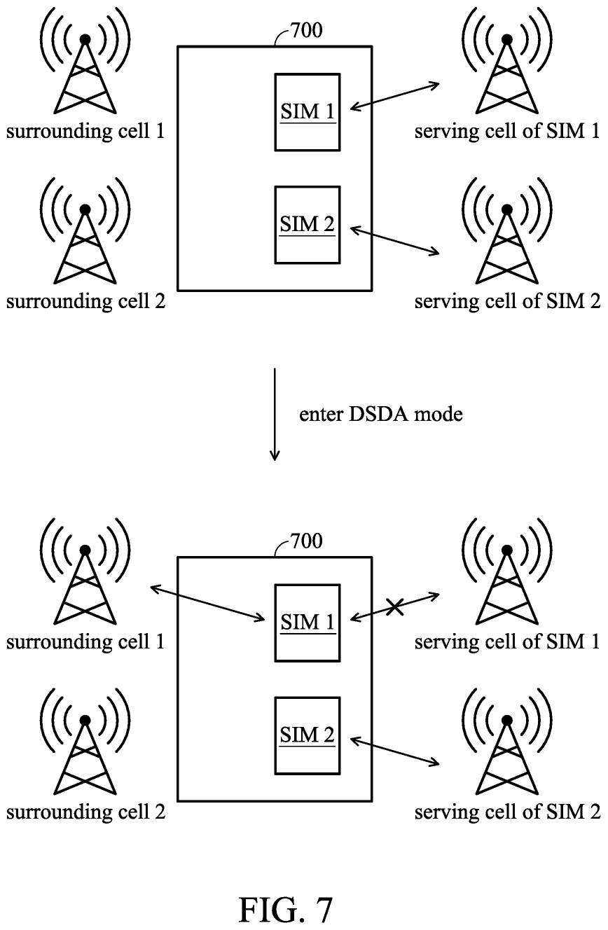

According to a fourth embodiment of the invention, when the second SIM is in a connected mode, the UE 110 may modify a measurement report to switch to the target cell to make sure that the UE 110 can support the DSDA mode. Specifically, the UE 110 may find at least one surrounding cell which can make the UE 110 can support the DSDA mode, and then the UE 110 may increase the signal quality of the found surrounding cells and reduce the signal quality of the cells which cannot make the UE 110 can support the DSDA mode to modify the measurement report. Then, the UE 110 may transmit the modified measurement report to the network node corresponding to the serving cell of the first SIM through the first SIM. When the network node corresponding to the serving cell of first SIM receives the modified measurement report, the network node may select a target cell from the found surrounding cells and perform a handover procedure (e.g., transmit a handover command to the first SIM) to switch the first SIM from the original serving cell to the target cell. After the handover procedure, the first SIM may camp on the target cell to perform the first service, and the second SIM may camp on its corresponding serving cell to perform the second service to make sure that the UE 110 can support or enter the DSDA mode. FIG. 7 is taken as an example to illustrate the third embodiment below.

FIG. 7 is a schematic diagram illustrating switching to DSDA mode according to the fourth embodiment of the invention. The UE 700 can be applied to UE 110. As shown in FIG. 7, it is assumed that the SIM 1 is in the connected mode, the SIM 2 is in the connected mode, and the UE 700 can currently only support DR-DSDA mode. When SIM 2 requires the second service and the UE 700 is performing the first service from the serving cell corresponding to the SIM 1, the UE 700 may find at least one surrounding cell which can make the UE 110 can support the DSDA mode, and then the UE 700 may increase the signal quality of the found surrounding cells and reduce the signal quality of the cells which cannot make the UE 700 can support the DSDA mode to modify the measurement report. Then, the UE 700 may transmit the modified measurement report to the network node corresponding to the serving cell of SIM 1. When the network node corresponding to the serving cell of SIM 1 receives the modified measurement report, the network node may select the target cell (i.e., surrounding cell 1) from the found surrounding cells and perform a handover procedure (e.g., transmit a handover command to the SIM 1) to switch the SIM 1 from the original serving cell to the target cell (i.e., surrounding cell 1). After the handover procedure, the SIM 1 may camp on the target cell to perform the first service and the SIM 2 may camp on its corresponding serving cell to perform the second service to make sure that the UE 700 can support or enter the DSDA mode.

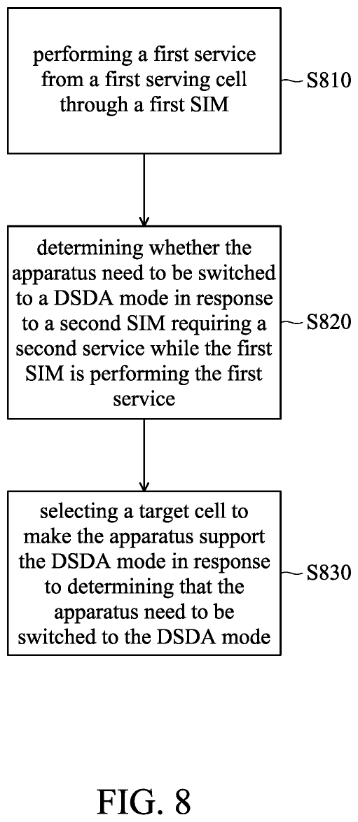

FIG. 8 is a flow chart illustrating a dual Subscriber Identity Module (SIM) transmission method according to an embodiment of the invention. The dual SIM transmission method can be applied to the wireless communications system 100. As shown in FIG. 8, in step S810, the UE 110 may perform a first service from a first serving cell through the first SIM of the UE 110.

In step S820, the UE 110 may determine whether the UE 110 need to be switched to a dual SIM dual active (DSDA) mode in response to a second SIM of the UE 110 requires a second service while the first service is performing.

In step S830, the UE 110 may select a target cell for the second service to make the UE 110 support the DSDA mode in response to determining that the apparatus needs to be switched to the DSDA mode.

According to an embodiment of the invention, in the dual SIM transmission method, the second SIM may be in a non-connected mode or in a connected mode.

According to an embodiment of the invention, in the dual SIM transmission method, in response to the second SIM being in the non-connected mode, the UE 110 may select the target cell through a cell re-selection process or a cell selection process to make the apparatus support the DSDA mode, and camp on the target cell to perform the second service.

According to an embodiment of the invention, in the dual SIM transmission method, in response to the second SIM being in the non-connected mode, the UE 110 may select the target cell through a cell re-selection process or a cell selection process to make the apparatus support the DSDA mode. Then, the second SIM may camp on a second serving cell to perform the second service, and the first SIM may camp on the target cell from the first serving cell to perform the first service.

According to an embodiment of the invention, in the dual SIM transmission method, in response to the second SIM being in the non-connected mode, the UE 110 may perform a Tracking Area Update (TAU) procedure or a Mobility Registration Update (MRU) procedure before the first SIM or the second SIM camps on the target cell.

According to an embodiment of the invention, in the dual SIM transmission method, in response to the second SIM being in the connected mode, the UE 110 may modify a measurement report through the second SIM to switch to the target cell to make the apparatus support the DSDA mode, and transmit the modified measurement report to a second serving cell through the second SIM. Then, the second SIM may be switched from the second serving cell to the target cell based on a handover procedure to perform the second service.

According to an embodiment of the invention, in the dual SIM transmission method, in response to the second SIM being in the connected mode, the UE 110 may modify a measurement report through the first SIM to switch to the target cell to make the apparatus support the DSDA mode, and transmit the modified measurement report to the first serving cell through the first SIM. Then, the second SIM may perform the second service from the second serving cell, and the first SIM may be switched from the first serving cell to the target cell based on a handover procedure to perform the first service.

According to an embodiment of the invention, in the dual SIM transmission method, in response to the second SIM being in the connected mode, the UE 110 may modify a measurement report through the first SIM or the second SIM by increasing the signal quality of the target cell.

According to an embodiment of the invention, in the dual SIM transmission method, the connected mode may be radio resource control (RRC) connected mode, and the non-connected mode may be an RRC idle mode or an RRC inactive mode.

According to an embodiment of the invention, in the dual SIM transmission method, the UE 110 may determine that the UE 110 needs to be switched to a DSDA mode in response to the UE 110 currently being in a dual receive-DSDA (DR-DSDA) mode.

According to the dual SIM transmission provided in the invention, the UE can make it can support or enter the DSDA mode when the UE does not support the DSDA mode originally. Therefore, the user can use the services provided by the SIMs of the UE simultaneously at the DSDA mode. In addition, according to the dual SIM transmission provided in the invention, better dual SIM user experience and better spectrum efficiency can be achieved.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A dual Subscriber Identity Module (SIM) transmission method, comprising:
performing, by a first SIM of an apparatus, a first service from a first serving cell;
determining, by a processor of the apparatus, whether the apparatus needs to be switched to a dual SIM dual active (DSDA) mode in response to a second SIM of the apparatus requiring a second service while the first SIM is performing the first service; and
selecting, by the processor, a target cell to make the apparatus support the DSDA mode in response to determining that the apparatus needs to be switched to the DSDA mode.

2. The dual SIM transmission method of claim 1, wherein the second SIM is in a non-connected mode or in a connected mode.

3. The dual SIM transmission method of claim 2, wherein in response to the second SIM being in the non-connected mode, the method further comprises:
selecting, by the processor, the target cell through a cell re-selection process or a cell selection process to make the apparatus support the DSDA mode; and
camping, by the second SIM, on the target cell to perform the second service.

4. The dual SIM transmission method of claim 2, wherein in response to the second SIM being in the non-connected mode, the method further comprises:
selecting, by the processor, the target cell through a cell re-selection process or a cell selection process to make the apparatus support the DSDA mode;
camping, by the second SIM, on a second serving cell to perform the second service; and
camping, by the first SIM, on the target cell from the first serving cell to perform the first service.

5. The dual SIM transmission method of claim 2, wherein in response to the second SIM being in the non-connected mode, the method further comprises:
performing, by the processor, a Tracking Area Update (TAU) procedure or a Mobility Registration Update (MRU) procedure before the second SIM or the first SIM camps on the target cell.

6. The dual SIM transmission method of claim 2, wherein in response to the second SIM being in the connected mode, the method further comprises:
modifying, by the second SIM, a measurement report to switch to the target cell to make the apparatus support the DSDA mode;
transmitting, by the second SIM, the modified measurement report to a second serving cell; and
switching, by the second SIM, from the second serving cell to the target cell based on a handover procedure to perform the second service.

7. The dual SIM transmission method of claim 2, wherein in response to the second SIM being in the connected mode, the method further comprises:
modifying, by the first SIM, a measurement report to switch to the target cell to make the apparatus support the DSDA mode;
transmitting, by the first SIM, the modified measurement report to the first serving cell;
performing, by the second SIM, the second service from a second serving cell; and
switching, by the first SIM, from the first serving cell to the target cell based on a handover procedure to perform the first service.

8. The dual SIM transmission method of claim 2, wherein in response to the second SIM being in the connected mode, the method further comprises:
modifying, by the first SIM or the second SIM, a measurement report by increasing a signal quality of the target cell.

9. The dual SIM transmission method of claim 2, wherein the connected mode is a radio resource control (RRC) connected mode, and the non-connected mode is an RRC idle mode or an RRC inactive mode.

10. The dual SIM transmission method of claim 1, further comprising:
determining, by the processor, that the apparatus needs to be switched to a DSDA mode in response to the apparatus currently being in a dual receive-DSDA (DR-DSDA) mode.

11. An apparatus for dual Subscriber Identity Module (SIM) transmission, comprising:
a first SIM;
a second SIM;
a transceiver; and
a processor, coupled to the transceiver, and configured to:
perform, via a first SIM, a first service from a first serving cell;
determine whether the apparatus needs to be switched to a dual SIM dual active (DSDA) mode in response to a second SIM of the apparatus requiring a second service while the first SIM is performing the first service; and
select a target cell to make the apparatus support the DSDA mode in response to determining that the apparatus needs to be switched to the DSDA mode.

12. The apparatus of claim 11, wherein the second SIM is in a non-connected mode or in a connected mode.

13. The apparatus of claim 12, wherein in response to the second SIM being in the non-connected mode, the processor is further configured to:
select the target cell through a cell re-selection process or a cell selection process to make the apparatus support the DSDA mode; and
camp, via the second SIM, on the target cell to perform the second service.

14. The apparatus of claim 12, wherein in response to the second SIM being in the non-connected mode, the processor is further configured to:
select the target cell through a cell re-selection process or a cell selection process to make the apparatus support the DSDA mode;
camp, via the second SIM, on a second serving cell to perform the second service; and
camp, via the first SIM, on the target cell from the first serving cell to perform the first service.

15. The apparatus of claim 12, wherein in response to the second SIM being in the non-connected mode, the processor is further configured to:
performing, by the processor, a Tracking Area Update (TAU) procedure or a Mobility Registration Update (MRU) procedure before the second SIM or the first SIM camps on the target cell.

16. The apparatus of claim 12, wherein in response to the second SIM being in the connected mode, the processor is further configured to:
modify, via the second SIM, a measurement report to switch to the target cell to make the apparatus support the DSDA mode;
transmit, via the second SIM, the modified measurement report to a second serving cell; and
switch, via the second SIM, from the second serving cell to the target cell based on a handover procedure to perform the second service.

17. The apparatus of claim 12, wherein in response to the second SIM being in the connected mode, the processor is further configured to:
modifying, by the first SIM, a measurement report to switch to the target cell to make the apparatus support the DSDA mode;
transmitting, by the first SIM, the modified measurement report to the first serving cell;
performing, by the second SIM, the second service from a second serving cell; and
switching, by the first SIM, from the first serving cell to the target cell based on a handover procedure to perform the first service.

18. The apparatus of claim 12, wherein in response to the second SIM being in the connected mode, the processor is further configured to:
modify, via the first SIM or the second SIM, a measurement report by increasing a signal quality of the target cell.

19. The apparatus of claim 12, wherein the connected mode is a radio resource control (RRC) connected mode, and the non-connected mode is an RRC idle mode or an RRC inactive mode.

20. The apparatus of claim 11, wherein the processor determines that the apparatus needs to be switched to a DSDA mode in response to the apparatus currently being in a dual receive-DSDA (DR-DSDA) mode.
